(19) United States
(12) Patent Application Publication
(10) Pub. No.: US 2006/0095746 A1
(43) Pub. Date: May 4, 2006

(54) Branch predictor, processor and branch prediction method

(75) Inventors: Masato Uchiyama, Kanagawa (JP); Takashi Miyamori, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/199,235

(22) Filed: Aug. 9, 2005

(30) Foreign Application Priority Data
Aug. 13, 2004 (JP) 2004-236121

(51) Int. Cl. G06F 9/00

(52) U.S. Cl. 712/239

(57) ABSTRACT

A branch predictor configured to communicate information between first and second thread execution units includes a first branch prediction table configured to store branch prediction information of the first thread execution unit. A second branch prediction table is configured to store branch prediction information of the second thread execution unit. A read address register is configured to access the first and second branch prediction tables based on a read address received from the first thread execution unit. A selector is configured to select one of the first and second branch prediction tables in accordance with the read address, to read the branch prediction information of one of the first and second thread execution units, and to supply read branch prediction information to the first thread execution unit when the second thread execution unit is in a wait state.

### CROSS REFERENCE TO RELATED APPLICATION AND INCORPORATION BY REFERENCE

This application is based upon and claims the benefit of priority from the prior Japanese Patent Applications No. P2004-236121 filed on Aug. 13, 2004; the entire contents of which are incorporated herein by reference.

### BACKGROUND OF THE INVENTION

1. Field of the Invention

The present invention relates to a processor, and more particularly, relates to a branch predictor and a branch prediction method for the processor.

2. Description of the Related Art

A recent multi-thread processor provides a plurality of thread execution units for executing individual thread.

However, the prediction precision of the branch result of threads is low and the performance of the processor decreases when the branch prediction fails.

### SUMMARY OF THE INVENTION

An aspect of the present invention inheres in a branch predictor configured to communicate information between first and second thread execution units encompassing, a first branch prediction table configured to store branch prediction information of the first thread execution unit, a second branch prediction table configured to store branch prediction information of the second thread execution unit, a read address register configured to access the first and second branch prediction tables based on a read address received from the first thread execution unit, and a selector configured to select one of the first and second branch prediction tables in accordance with the read address, to read the branch prediction information of one of the first and second thread execution units, and to supply read branch prediction information to the first thread execution unit when the second thread execution unit is in a wait state.

An another aspect of the present invention inheres in a processor encompassing, first and second thread execution units, a first branch prediction table configured to store branch prediction information of the first thread execution unit, a second branch prediction table configured to store branch prediction information of the second thread execution unit, a read address register configured to access the first and second branch prediction tables based on a read address received from the first thread execution unit, and a selector configured to select one of the first and second branch prediction tables in accordance with the read address, to read the branch prediction information of one of the first and second thread execution units, and to supply read branch prediction information to the first thread execution unit when the second thread execution unit is in a wait state.

Still another aspect of the present invention inheres in a branch prediction method for communicating information between first and second thread execution units, encompassing, receiving a read address from the first thread execution unit, accessing first and second branch prediction tables based on the read address, determining a wait state of the second thread execution unit, and supplying branch prediction information of the second thread execution unit to the first thread execution unit by reading the branch prediction information of the second thread execution unit from the second branch prediction table based on the read address when the second thread execution unit is in a wait state.

### BRIEF DESCRIPTION OF THE DRAWINGS

FIG. 1 is a block diagram showing a branch predictor according to an embodiment of the present invention.

FIG. 2 is a block diagram showing a processor including the branch predictor according to the embodiment of the present invention.

FIG. 3 is an operational flow chart showing the processor including the branch predictor according to the embodiment of the present invention.

FIG. 4 is a block diagram showing an instruction fetch unit according to the embodiment of the present invention.

FIG. 5 is a block diagram showing a branch predictor according to the embodiment of the present invention.

FIG. 6 is a state transition diagram showing branch prediction information for the branch predictor according to the embodiment of the present invention.

FIG. 7 is a state transition diagram showing branch prediction information for the branch predictor according to the embodiment of the present invention.

FIGS. 8A and 8B are tables showing branch prediction information for the branch predictor according to the embodiment of the present invention.

FIG. 9 is a time chart showing an operation of the branch predictor according to the embodiment of the present invention.

FIG. 10 is a time chart showing an operation of the branch predictor according to the embodiment of the present invention.

FIG. 11 is a flow chart showing a branch prediction method according to the embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. In the following descriptions, numerous specific details are set forth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail. In the following description, the words “connect” or “connected” define a state in which first and second elements are electrically connected to each other without regard to whether or not there is a physical connection between the elements.

(System Example of Branch Predictor)

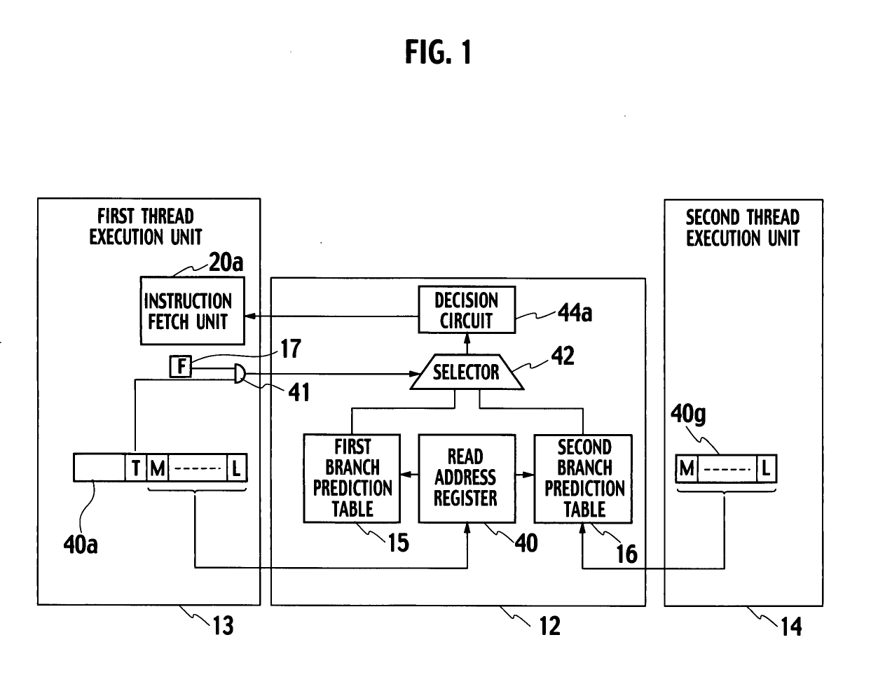

As shown in FIG. 1, a branch predictor according to an embodiment of the present invention includes a first branch prediction table 15 configured to store branch prediction information of the first thread execution unit 13, a second branch prediction table 16 configured to store branch prediction information of the second thread execution unit 14, a read address register 40 configured to access the first and second branch prediction tables 13 and 14 based on a read address received from the first thread execution unit 13, and a selector 42 configured to select one of the first and second branch prediction tables 15 and 16 in accordance with the read address, to read the branch prediction information of one of the first and second thread execution units 13 and 14, and to supply read branch prediction information to the first thread execution unit 13 when the second thread execution unit is in a wait state.

The first thread execution unit 13 includes an instruction fetch unit 20a configured to receive branch prediction information, a common flag 17 configured to indicate a common condition of the second branch prediction table 16, a branch instruction address register 40a, and a switch circuit 41.

The second thread execution unit 14 is connected to the second branch prediction table 16, and includes a branch instruction address register 40g configured to supply a branch instruction address.

Furthermore, the branch predictor 12 includes a decision circuit 44a connected to an output side of selector 42. The decision circuit 44a decides a success ratio of the branch prediction information.

The decision circuit 44a is connected to the instruction fetch unit 20a. The selector 42 is connected to the switch circuit 41. The branch instruction address register 40a of the first thread execution unit 13 is connected to the read address register 40. The switch circuit 41 is connected to both a table switch bit “T” in the branch instruction address register 40a and the common flag 17.

In the branch predictor 12, the first thread execution unit 13 can utilize the second branch prediction table 16 based on an output signal of switch circuit 41 supplying an AND result of the common flag 17 and table switch bit “T” when the second thread execution unit 14 is in a wait state. It is possible to increase the branch prediction precision of the first thread execution unit 13 by substantially expanding a branch prediction table.

The wait state of the second thread execution unit 14 refers to cycles incapable of executing parallel processing. When a ratio of the cycles incapable of executing parallel processing is comparatively large, it is possible to increase the branch prediction precision of the first thread execution unit 13, and to increase the efficiency of a program execution of a parallel processing device.

(Processor Example Including Branch Predictor)

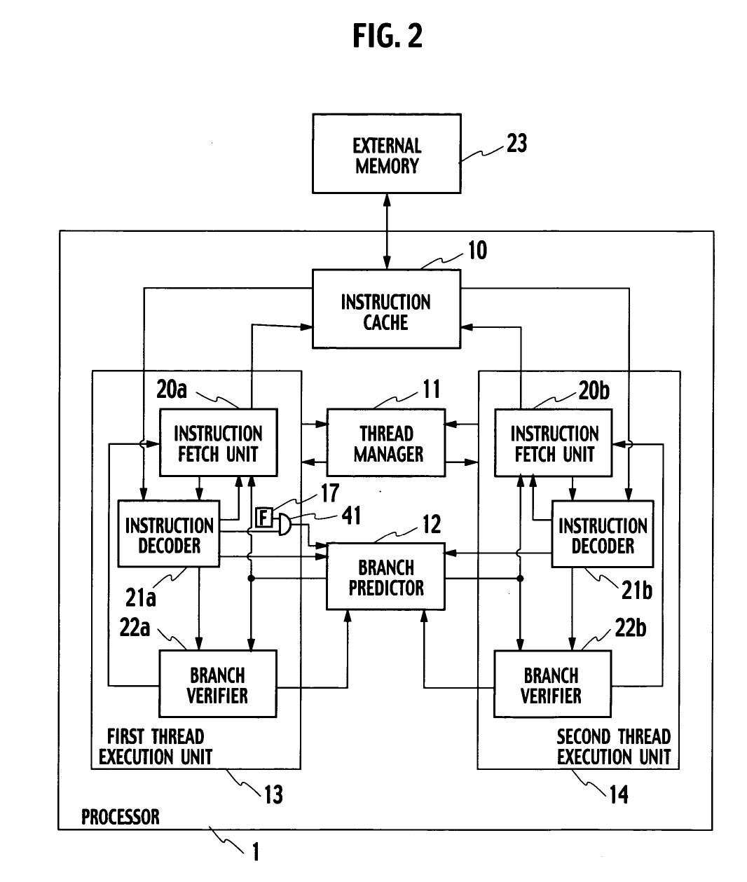

As shown in FIG. 2, a processor 1 provided with the branch predictor 12 shown in FIG. 1 includes an instruction cache 10, the thread manager 11, the branch predictor 12, the first thread execution unit 13, and the second thread execution unit 14.

The first thread execution unit 13 includes the instruction fetch unit 20a connected to the instruction cache 10, the instruction decoder 21a connected to the instruction cache 10 and the instruction fetch unit 20a, a branch verifier 22a connected to the instruction fetch unit 20a and the instruction decoder 21a, and the switch circuit 41 connected to the instruction decoder 21a and the common flag 17.

The instruction decoder 21a includes the branch instruction address register 40a shown in FIG. 1. The branch instruction address register 40a supplies a signal of the table switch bit “T” shown in FIG. 1 to the switch circuit 41.

However, the branch instruction address register 40a may be provided externally of the instruction decoder 21a. That is, the branch instruction address register 40a may be independent of the other circuits, such as the instruction fetch unit 20a.

The second thread execution unit 14 includes an instruction fetch unit 20b connected to the instruction cache 10, an instruction decoder 21b connected to the instruction cache 10 and the instruction fetch unit 20b, and a branch verifier 22b connected to the instruction fetch unit 20b and the instruction decoder 21b.

The branch instruction address register 40g shown in FIG. 1 is omitted in FIG. 2. However, the branch instruction address register 40g may provide in the instruction decoder 21b. Or, the branch instruction address register 40g may be independent of the instruction decoder 21b in accordance with circuit design variations.

The first thread execution unit 13 utilizes the first and second branch prediction tables 15 and 16 while the second thread execution unit 14 is a wait state. As a result, it is possible to greatly improve the condition branch prediction precision of the first thread execution unit 13.

When multi-thread processing is executed by operating the first and second thread execution units 13 and 14, a period in which other thread execution units are in a wait state occurs in a sequential part of the program.

For example, the processor 1 improves predict precision of branch instructions of threads, and improves the efficiency of branch instruction processing when the second thread execution unit 14 is in a wait state.

In the embodiment of the present invention, it is possible to increase conditional branch instruction precision, by utilizing the branch predictor 12 of a waiting thread execution unit when the processor 1 executes parallel processing.

(Processor Example of Pipeline System)

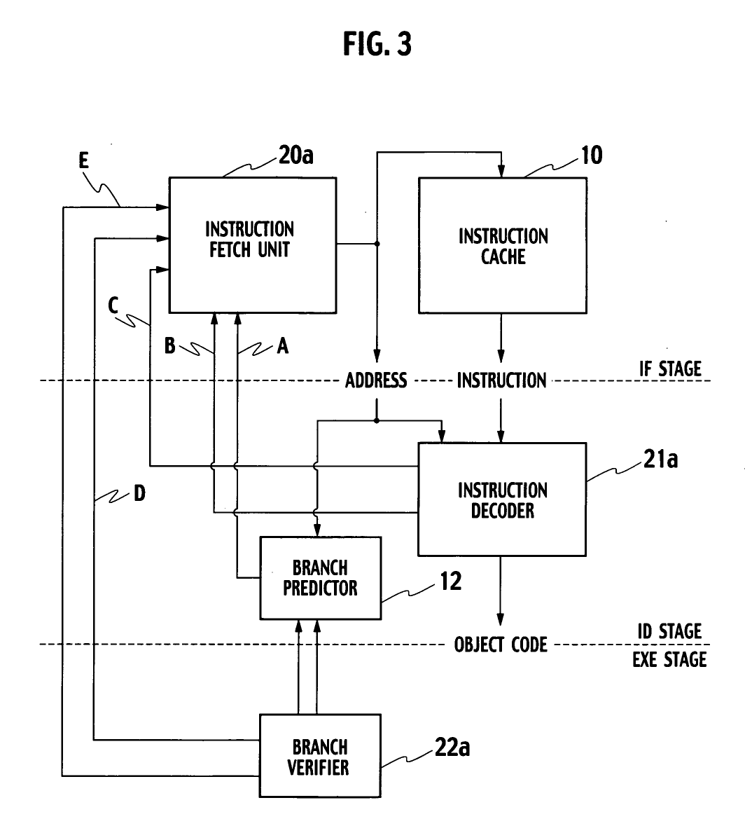

FIG. 3 is a flowchart showing the process sequence of the processor 1 providing the branch predictor 12 shown in FIG. 1 and FIG. 2. The process sequence of the first thread execution unit 13 is shown in FIG. 3.

In the processor 1 of a pipeline system, when the second thread execution unit 14 is in a wait state, the instruction decoder 21a, the branch predictor 12, the instruction cache 10 of the first thread execution unit 13, and the instruction fetch unit 20a of the first thread execution unit 13, the branch verifier 22a of the first thread execution unit 13 are operated.

In this case, the first thread execution unit 13 accesses the first and second branch prediction tables 15 and 16 via the read address register 40 shown in FIG. 1.

The switch circuit 41 subjects the selector 42 shown in FIG. 1 to select the branch prediction information read out from the second branch prediction table 16 when the common flag 17 is logic value “1” and the table switch bit “T” is logic value “1”. The branch prediction information read out from the second branch prediction table 16 is received by the instruction fetch unit 20a of the first thread execution unit 13 via the decision circuit 44a shown in FIG. 1.

As shown in FIG. 3, an instruction fetch stage (hereinafter referred to as “IF stage”) operating the instruction cache 10 and the instruction fetch unit 20a, an instruction decode stage (hereinafter referred to as “ID stage”) operating the instruction decoder 21a and the branch predictor 12, and an execution stage (hereinafter referred to as “EXE stage”) operating the branch verifier 22a, and the first thread execution unit 13 processes branch instructions.

The branch predictor 12 is connected to the branch verifier 22a, and receives a branch instruction execution signal and a branch result. The instruction fetch unit 20a is connected to the branch predictor 12, and receives a branch prediction result A from the branch predictor 12. The instruction fetch unit 20a is connected to the instruction decoder 21a, and receives a branch instruction detection signal B and a branch target address C from the instruction decoder 21a.

The instruction fetch unit 20a is connected to the branch verifier 22a, and receives a next cycle fetch address D and an address selection signal E from the branch verifier 22a.

The instruction cache 10 is connected to the instruction decoder 21a, and supplies a fetched instruction to the instruction decoder 21a of the first thread execution unit 13. The instruction decoder 21a decodes the instruction, and generates an object code.

The operation of the processor 1 of a pipeline system will be described by referring to FIG. 2 and FIG. 3.

The processor 1 executes each stage of the IF stage, the ID stage, and the EXE stage in synchronization with machine cycles.

In the IF stage, the instruction fetch unit 20a accesses the instruction cache 10, and reads out an instruction from the instruction cache 10, based on address of the program counter.

In the ID stage, the instruction cache 10 supplies an instruction to the instruction decoder 21a so as to generate an object code. The address of the program counter generated by the instruction fetch unit 20a is supplied to the instruction decoder 21a and the branch predictor 12.

In the ID stage, the branch predictor 12 transmits the branch prediction result A of the branch instruction to the instruction fetch unit 20a, and informs the instruction fetch unit 20a of the hit rate of instruction executed in the next pipeline stage.

In the EXE stage, the branch verifier 22a verifies whether the branch of object code generated by the instruction decoder 21a is satisfied or not. The branch verifier 22a feeds back the branch prediction result, which indicates whether the branch predictor 12 has correctly predicted the result, to the instruction fetch unit 20a.

At the same time, the branch verifier 22a feeds back the branch prediction result to the branch predictor 12. The branch prediction result is utilized to update branch prediction information of the first and second branch prediction tables 15 and 16 shown in FIG. 1.

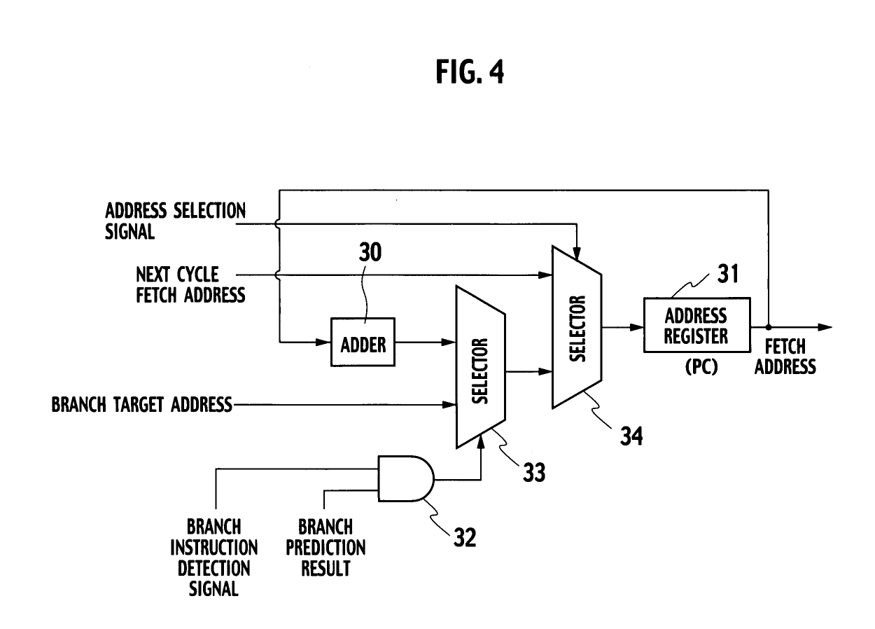

FIG. 4 is a block diagram showing the instruction fetch unit 20a of the first thread execution unit 13 shown in FIG. 1 to FIG. 3. The instruction fetch unit 20a includes an adder 30, a selector 33 configured to receive the addition result of the adder 30 and a branch target address, a selector 34 configured to receive the next cycle fetch address and selection result of the selector 33, address register 31 (or program counter (PC)) connected to an output of the selector 34, and an AND circuit 32 configured to receive a branch prediction result and a branch instruction detection signal. The instruction fetch unit 20a supplies the fetch address to the instruction cache 10 shown in FIG. 3.

The selector 33 receives an operation result of the AND circuit 32, and selects either one of a branch target address and an output of the adder 30. The selected signal of the selector 33 is received by one input terminal of the next stage selector 34.

The selector 34 selects either one of the next cycle fetch address and the selected signal of the selector 33 in accordance with the address selection signal, and transmits the next stage address register 31. The address register 31 transmits a fetch address to the instruction cache 10.

The adder 30 adds the pre-cycle fetch address to a “4” address value. When a pipeline stage not including a branch instruction is processed, the selector 34 selects the fetch address supplied by the adder 30 without selecting the next cycle fetch address.

For example, when there is a high possibility that a branch instruction is “taken”, the AND circuit 32 receives a high level signal of the branch prediction result transmitted by the branch predictor 12 shown in FIG. 3 and a high level signal of the branch instruction detection signal transmitted by the instruction decoder 21a shown in FIG. 3, and generates a high level signal so as to select the branch target address by the selector 33. Here, the term “taken” refers to branching by satisfying a branch condition. The term “not taken” refers to a state that branch is not executed by failing a branch condition.

On the other hand, when a pipeline stage is not a branch instruction, the selector 33 selects an output of the adder 30, and transmits the output of the adder 30 to the address register 31 via the selector 34.

Furthermore, the address selection signal becomes a high level signal when the branch prediction is “not taken”. In this case, the selector 34 transmits the next cycle fetch address to the address register 31 via the selector 34.

As described above, it is possible to improve precision of the branch prediction by selecting the next cycle fetch address in response to the branch prediction result and the branch instruction detection signal.

(Branch Predictor)

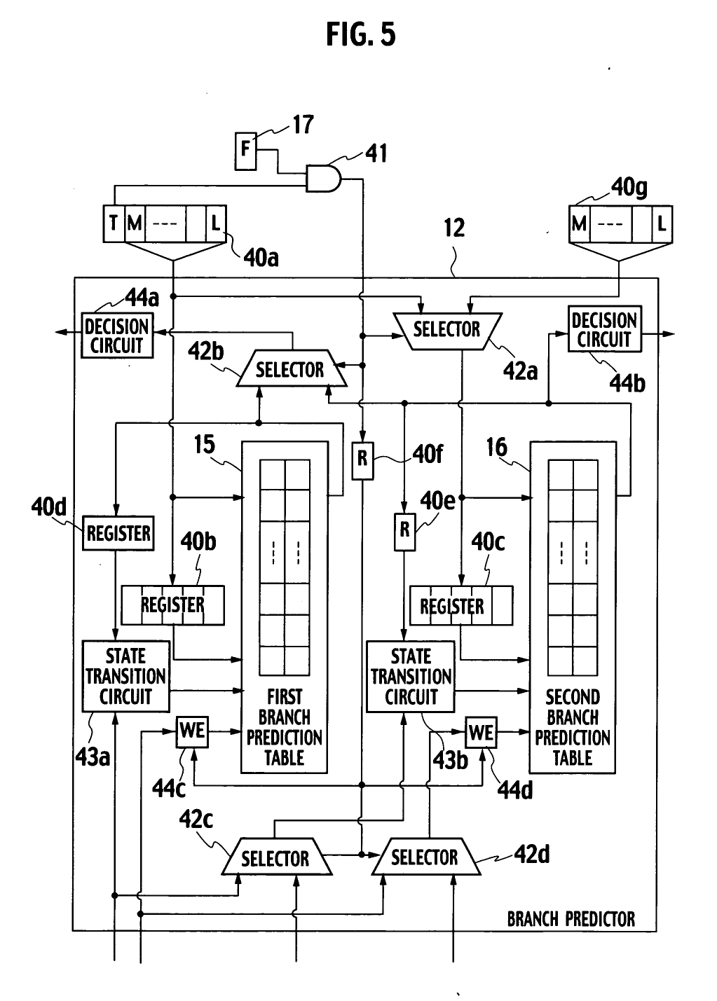

FIG. 5 is a block diagram showing the branch predictor 12 shown in FIG. 1 to FIG. 3. The branch predictor 12 includes the first branch prediction table 15 and the second branch prediction table 16. The branch predictor 12 further includes a pre-prediction address register 40b, a selector 42c, a first branch prediction table 15, a selector 42d, a pre-state register 40d, a decision circuit 44a, a state transition circuit 43a, a write enable generator 44c (hereinafter referred to as “WE”.), a selector 42a, a second branch prediction table 16, a pre-prediction address register 40c, a selector 42b, a decision circuit 44b, a pre-state register 40e, a state transition circuit 43b, and a WE 44d, a pre-select register 40f.

The selector 42b and the pre-state register 40d are connected to the first branch prediction table 15. The decision circuit 44a is connected to an output of the selector 42b. The state transition circuit 43a is connected to the pre-state register 40d. The WE 44c is connected to the first branch prediction table 15. The selector 42a is connected to the branch instruction address register 40g. The second branch prediction table 16 and the pre-prediction address register 40c are connected to the selector 42a. The selector 42b, the decision circuit 44b, and the pre-state register 40e are connected to the second branch prediction table 16. The state transition circuit 43b is connected to the pre-state register 40e. The WE 44d is connected to the second branch prediction table 16. The pre-select register 40f is connected to the switch circuit 41. The selectors 42c and 42d are connected to the pre-select register 40f.

The first branch prediction table 15 receives a branch instruction address including a bit group from the most significant bit (MSB) to the least significant bit (LSB) of the branch instruction address register 40a as the read address.

The pre-state register 40d updates the first branch prediction table 15 in accordance with the branch prediction result transmitted by the branch verifier 22a shown in FIG. 2.

The WE 44c receives a branch instruction execution signal, and updates the first branch prediction table 15.

The selector 42c receives a switch signal from the switch circuit 41 via the pre-select register 40f, and selects one branch prediction result of branch verifiers 22a and 22b shown in FIG. 2.

The selector 42b is connected to the switch circuit 41, and selects branch prediction information of the first branch prediction table 15 or the second branch prediction table 16. The decision circuit 44a generates a first branch prediction result based on the branch prediction information transmitted by the selector 42b.

The second branch prediction table 16 is connected to the selector 42a that selects an output of the branch instruction address register 40a or the branch instruction address register 40g, and receives the read address.

The branch instruction address register 40g supplies a branch instruction address including the bit group, from the most significant bit (MSB) to the least significant bit (LSB), to the pre-prediction address register 40c as the read address.

The second branch prediction table 16 receives the branch instruction address stored in the pre-prediction address register 40c as the write address. The second branch prediction table 16 may be updated to correspond to a branch verification result of the branch verifier 22b shown in FIG. 2, in response to a write enable signal of the WE 44d.

The selector 42d receives a switch signal from the switch circuit 41 via the pre-select register 40f, and selects a branch instruction execution signal from the branch verifier 22a or the branch verifier 22b.

The second branch prediction table 16 transmits branch prediction information via the decision circuit 44b.

(Branch Prediction Table)

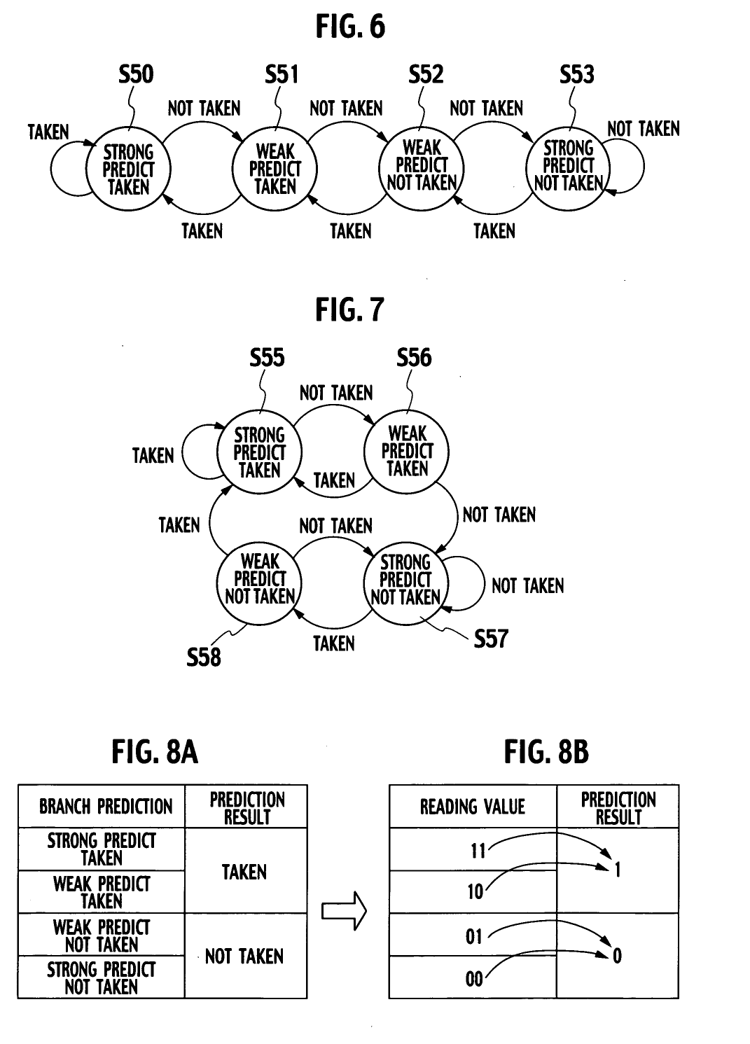

The branch predictor according to the embodiment of the present invention decides the probability of the branch “taken” prediction by two bits state transition as the branch prediction information, as shown in FIG. 6.

When the branch prediction is “taken” with the highest branch “taken” probability, in the strongly predict “taken” step S50, the branch predictor 12 shown in FIG. 5 maintains a strongly predict “taken” step S50 by using branch prediction information of the branch prediction table 15 or the branch prediction table 16.

In the strongly predict “taken” step S50, when the strongly predict “taken” step S50 is “not taken”, the procedure goes to a weakly predict “taken” step S51. The weakly predict “taken” step S51 is a state of the second highest branch “taken” probability of the branch predictor 12.

When the branch prediction is satisfied with the second highest branch “taken” probability in strongly predict “taken” step S51, the branch predictor 12 transfers the strongly predict “taken” step S50 by using branch prediction information of the branch prediction table 15 or the branch prediction table 16.

In the weakly predict “taken” step S51, when the branch prediction is “not taken”, the procedure goes to a weak predict “not taken” step S52. The weakly predict “not taken” step S52 is a state of the third highest branch “taken” probability of the branch predictor 12.

When the branch prediction is “taken” with the third highest branch “taken” probability in the weakly predict “not taken” step S52, the branch predictor 12 transfers the weakly predict “taken” step S51 by using branch prediction information of the branch prediction table 15 or the branch prediction table 16.

In the weakly predict “not taken” step S52, when the branch prediction is “not taken”, the procedure goes to a strongly predict “not taken” step S53. The strongly predict “not taken” S53 is a state of the fourth highest branch “taken” probability of the branch predictor 12.

When the branch prediction is succeeded with the least branch “taken” probability in the strongly predict “not taken” step S53, the branch predictor 12 transfers the weakly predict “not taken” step S52 by using branch prediction information of the branch prediction table 15 or the branch prediction table 16.

In the strongly predict “not taken” step S53, when the branch prediction is “not taken”, the procedure maintains the strongly predict “not taken” step S53.

As shown in FIG. 7, the present invention is not limited to the procedure of strongly predict “taken” step S50 to strongly predict “not taken” S53 shown in FIG. 6. In FIG. 7, the procedure goes to the weakly predict “taken” step S56 after the strongly predict “taken” step S55, the procedure goes to the strongly predict “not taken” step S57 after the weakly predict “taken” step S56, the procedure goes to the weakly predict “not taken” step S58 after the strongly predict “not taken” step S57, the procedure goes to the strongly predict “taken” step S55 after the weak predict “not taken” step S58. That is, the procedure of the branch prediction is a matter of design variation.

The present invention is not limited to the procedure of deciding the next branch prediction in accordance with “taken” or “not taken” of the branch prediction. As shown in FIG. 8B, the decision circuit 44a or the decision circuit 44b selects an upper one bit in the read value (two bit for instance) of the first branch prediction table 15 or the second branch prediction table 16, and obtains the branch prediction result.

When the read value of the first branch prediction table 15 or second branch prediction table 16 is “strongly predict taken” and “weakly predict taken” shown in FIG. 8A, the decision circuit 44a or the decision circuit 44b selects the upper one bit in the read value, and decides the branch “taken” (bit “1”), as shown in FIG. 8B.

When the read value of the first branch prediction table 15 or second branch prediction table 16 is the strongly predict “not taken” and the weakly predict “not taken” shown in FIG. 8A, the decision circuit 44a or the decision circuit 44b selects upper one bit in the read value, and decides the branch “not taken” (bit “0”), as shown in FIG. 8B.

(Branch Taken Example of a Pipeline Processor)

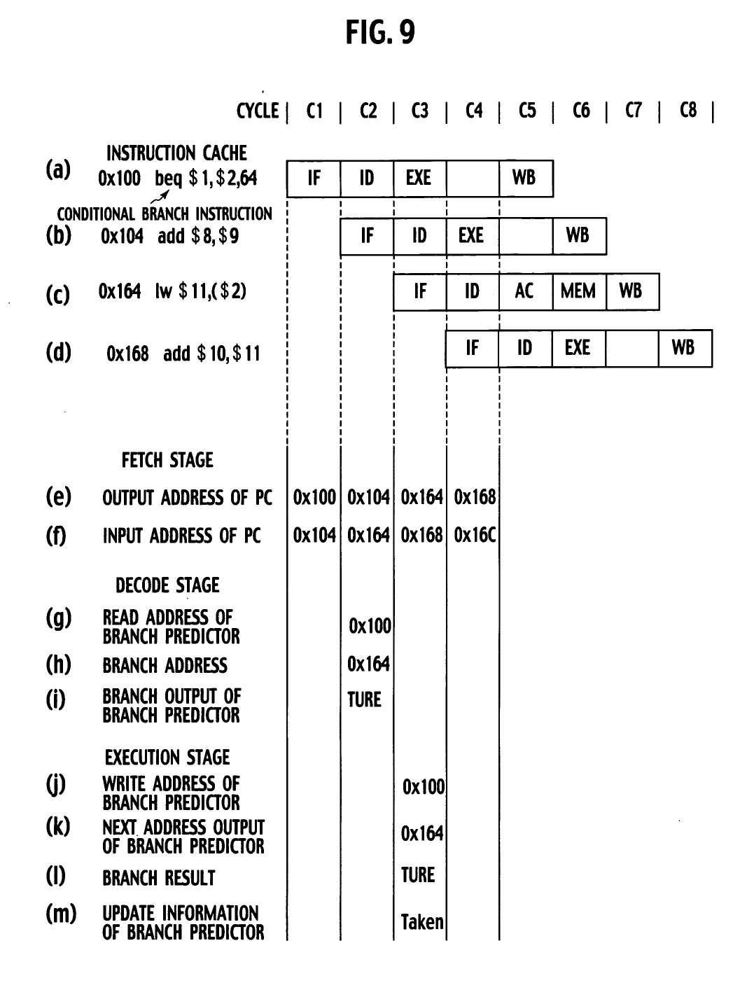

FIG. 9 is a time chart showing an operation of the pipeline processor providing the branch predictor according to the embodiment of the present invention. The operation of the processor 1 will be described by referring to FIG. 2 and FIG. 9.

In the following description, registers A, B, and C refer to “pipeline register”, “general register” refers to a group of 16 to 32 the term registers. The group of registers corresponds to “general register file” of a pipeline processor.

The register A stores an instruction code (indicated “beq” of six bits, for instance), a first general register number (indicated “$8” of five bits, for instance) as an operand, a second general register number (indicated “$9” of five bits, for instance) as an operand, a relative addressing (by “branching to address added “0x64” of 16 bits, for instance).

The register A has 32 bits, and stores data (instruction, for instance) read from the instruction cache 10. The instruction cache 10 stores a plurality of instructions having 32 bits.

The register C stores the decoded instruction code (indicated “beq” of several bits of 20 bits, for instance), a first general register number (having 32 bits, for instance) as an operand, a second general register number (having 32 bits, for instance) as an operand, and a branch target address (having 32 bits for instance).

The first thread execution unit 13 processes each instruction in synchronization with clock cycles (C1 to C8) by pipeline system, as shown in FIG. 9(a) to FIG. 9(d).

The first thread execution unit 13 executes a program including branch instructions. As shown in FIG. 9(a), a branch instruction including a condition of “beq” is processed by the pipeline system. An address of program counter (PC) of a fetch stage, a decode stage, and an execution stage relating to a branch control of each pipeline stage is generated.

For example, the instruction cache 10 stores the branch instruction including the condition of “beq” in the address “0x100”. The code “0x” refers to a hexadecimal number.

The register B stores the address “0x100” utilized for reading the instruction from the instruction cache. The register A directly stores the instruction from the instruction cache. When the content of the instruction cache of the address “0x100” is read, the register A stores an instruction code of “beq” and general registers “$1,” and “$2”, and a branch offset “0x64” utilized for deciding branch condition. The register B stores the address “0x100.

As shown in FIG. 9(b), when the content of the instruction cache of the address “0x104” is read, the register A stores an instruction code of “add” and general register numbers “$8” and “$9”.

As shown in FIG. 9(c), when the content of the instruction cache of the address “0x164” is read, the register A stores a instruction code of “1w” and general register numbers “$10” and “$11”.

The processor 1 processes each instruction of “beq” and “add” by the execution cycle composed by five pipeline stages. Each pipeline stage includes an instruction fetch (IF), an instruction decode (ID), an instruction execution (EXE), memory access (MEM), and a register write-back (WB), as shown in FIG. 9(a), FIG. 9(b), and FIG. 9(d).

When the instruction is “1w”, each pipeline stage includes the IF, the ID, an address calculation (AC), the MEM, and the WB, as shown in FIG. 9(c).

When the conditional branch instruction shown in FIG. 9(a) is executed by operating the branch predictor 12, there are four branch processing instructions because the combination of the branch prediction result and the branch result is four.

The process of the processor 1 is different in a case where the branch prediction and the branch result are “taken”, from a case where the branch prediction is “taken” and the branch result is “not taken”.

The branch control of the processor 1 will be described about a case where the branch prediction and the branch result are “taken”.

The processor 1 fetches an instruction of the address “0x100” in the cycle C1. For example, the instruction fetch unit 20a transmits the “0x100” address to the instruction cache 10 and the pipeline register as a fetch address.

The processor 1 compares the general registers “$1,” and “$2” designated by the first and second operands. When the general registers “$1” and “$2” are equal, the processor 1 branches the address to a relative address by adding “0x64” to “0x100”.

On the other hand, when the general registers “$1” and “$2” are not equal, the “beq” instruction read from the instruction cache 10 is written to the pipeline register at the end of the IF stage. At the same time, the processor 1 writes the “0x100” address to the pipeline register.

The instruction fetch unit 20a detects an off state (low level) of the branch instruction detection signal generated by the instruction decoder 21a and the address selection signal generated by the branch verifier 22a. The instruction fetch unit 20a selects an output of the adder 30 shown in FIG. 4, and writes the address to the address register 31 shown in FIG. 4 at the end of the IF stage.

In the cycle C2, the processor 1 fetches an “add” instruction of the “0x104” address in the IF stage shown in FIG. 9(b), and decodes the “beq” instruction of the “0x100” address in ID stage shown in FIG. 9(a).

The instruction decoder 21a of the first thread execution unit 13 receives the read address “0x100” shown in FIG. 9(g) and read an instruction (the “beq” instruction, for instance), and generates control signals or data, and writes the generated data to the pipeline register at the end of the pipeline stage.

When the decoded instruction is a branch instruction, the first thread execution unit 13 detects an on state (high level) of the branch instruction detection signal generated by the instruction decoder 21a, and generates a branch address “0x164” shown in FIG. 9(h). The branch predictor 12 transmits the “0x100” address of the branch prediction result of the conditional branch instruction, as shown in FIG. 9(g).

The processor 1 sets a logic value “0” to the common flag 17 shown in FIG. 1. The branch predictor 12 generates the branch prediction result by utilizing the first branch prediction table 15 or the second branch prediction table 16 based on control of the first thread execution unit 13 or the second thread execution unit 14.

When the common flag 17 is set to logic value “0”, the processor 1 operates a branch prediction block by utilizing the first branch prediction table 15 based on the control of the first thread execution unit 13.

The branch predictor 12 receives a bit group from LSB to LSB (from the lower n bit to the lower three bit, for instance) of the branch instruction address stored in the branch instruction address register 40a as read address “0x40” of the first branch prediction table 15, and reads out the branch prediction data.

For example, the processor 1 writes an instruction having 32 bits to the instruction cache 10 in each four bytes of the head address storing the instruction, and omits the lower two bits of the read address because the lower two bits is a binary code “00”.

In executing threads, the decision circuit 44a shown in FIG. 5 receives the read value “11” (or data) having two bits length read out from the address “0x40” of the first branch prediction table 15, by utilizing a dynamic branch prediction system of two bits counter system, via the selector 42b shown in FIG. 5. At the same, the read value “11” is supplied to the pre-state register 40d.

The branch predictor 12 supplies the read address “0x40” to the pre-prediction address register 40b, and writes the read address “0x40” at the end of the pipeline stage.

The decision circuit 44a supplies a branch prediction output “TRUE” of the branch “taken” in accordance with the relationship of the read value of the first branch prediction table 15 and the branch prediction result, as shown in FIG. 9(i). Here, the read value is set to binary code “00” when the strongly predict “not taken”. The read value is set to binary code “01” when the weakly predict “not taken”. The read value is set to binary code “10” when the weakly predict “taken”. The read value is set to binary code “11” when the strongly predict “taken”.

The instruction fetch unit 20a detects an on state of a high level signal of the branch instruction detection signal. Since the branch prediction output is set to “TRUE” as shown in FIG. 9(i), the branch target address generated by the instruction decoder 21a is selected, and is written to address register 31 shown in FIG. 4 as the PC address at the end of the pipeline stage.

The processor 1 executes the IF stage of an instruction of the address “0x164” shown in FIG. 9(k) in the cycle C3, and executes the ID stage of an instruction of the address “0x104”. At the same time, an instruction of the address “0x100” shown in FIG. 9(j) is executed in the EXE stage.

The first thread execution unit 13 reads out an object code from the register C, and executes the object code in the EXE stage.

In EXE stage of the conditional branch instruction shown in FIG. 9(a), the first thread execution unit 13 reads out the object code from the register C, and transmits the object code to an operator (not illustrated). The operator executes an operation of the designated condition.

The branch verifier 22a sets branch instruction execution signal to a high level of an on state when the instruction in the EXE stage is the conditional branch instruction, as shown in FIG. 9A. In this case, the condition is satisfied; for example, the contents of the registers “$1” and “$2” are equal. Since the “TRUE” of the branch result shown in FIG. 9(l) in ID stage of the pre-cycle corresponds, the address selection signal is set to low level of an off state.

In the branch predictor 12, the state transition circuit 43a receives both the output of pre-state register 40d shown in FIG. 5 of the “11” of strongly predict “taken” and the output of the branch result. For example, with the update information “taken” shown in FIG. 9(m) is generated, the next state branch prediction information is generated. The generated next state branch prediction information is supplied to the decision circuit 44a.

The branch predictor 12 transfers “11” of strongly predict “taken” to “11” of strongly predict “taken” in accordance with the state transition system shown in FIG. 7, and maintains the next state branch prediction information to “11” of strongly predict “taken”.

Since the branch instruction execution signal is set to a high level, and the reading of the pre-cycle from first branch prediction table 15 is performed, an output signal of the write enable generator 44c is set to an enable state. The generated the next branch prediction information is written to the first branch prediction table 15 in accordance with the pre-prediction address “0x40” as the write address, at the end of the pipeline stage.

In the instruction fetch unit 20a, the branch instruction detection signal from the instruction decoder 21a is an off state in the ID stage, and the address selection signal from the branch verifier 22a is an off state in the EXE stage because the instruction “add” is not a branch instruction.

The instruction fetch unit 20a selects an output “0x168” of the adder 30 configured to add “4” address to the current fetch address as a read address of an instruction in next cycle, and writes the output “0x168” to address register 31 at the end of the pipeline stage.

As described above, when the branch predictor 12 predicts that the branch prediction result is a branch “taken”, and the branch result is a branch “taken”, the processor 1 predicts branch “taken” of the conditional branch instruction shown in FIG. 9(a) of the address “0x100”, and speculatively executes an instruction of the branch target address “0x164” in the cycle C3 after an instruction “add” of the address “0x104” in the cycle C2.

On the other hand, the result of branch “taken” is obtained in the cycle C3. Since the result corresponds the branch prediction, it is possible to continuously execute the instruction “1w” shown in FIG. 9(c) of the address “0x164”. It is possible to increase the processing speed of a program.

(Branch not Taken Example of a Pipeline Processor)

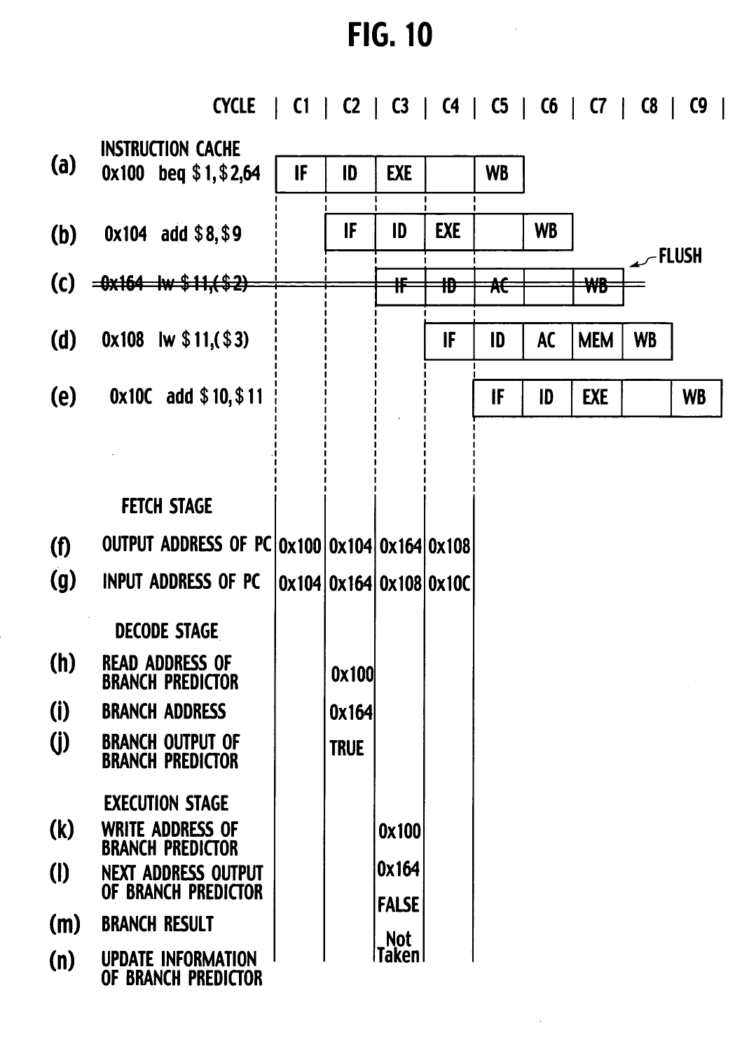

FIG. 10 is a time chart showing an operation of the pipeline processor providing the branch predictor according to the embodiment of the present invention. The operation of the processor 1 will be described by referring to FIG. 2 and FIG. 10.

As shown in FIG. 10(c), the branch predictor 12 deletes an instruction stored in instruction cache 10 when the branch prediction output shown in FIG. 10(j) is “TRUE” indicating a branch “taken”, and the branch result shown in FIG. 10(m) is “FALSE” indicating a branch “not taken”.

Since the procedure of the processor 1 in the cycles C1 and C2 is similar to the FIG. 9, repeated descriptions are omitted.

The processor 1 executes the IF stage of an instruction “1w” of the address “0x164” shown in FIG. 10(c) in the cycle C3, and executes the ID stage of an instruction “add” of the address “0x104”, and executes the EXE stage of an instruction of the address “0x100”.

In the EXE stage of conditional branch instruction “beq” shown in FIG. 10(a), the first thread execution unit 13 reads out data from the designated register, and supplies the data to an operator (not illustrated). The operator executes the operation of the designated condition, and supplies the operation result to the branch verifier 22a.

The branch verifier 22a set the branch instruction execution signal to an on state because the instruction “beq” is a conditional branch instruction. The instruction “beq” becomes a branch “not taken” when the designated condition is “not taken”. For example, the verifier 22a sets the branch instruction execution signal to an on state as the verification result of a branch “not taken” when the contents of the registers “$1” and “$2” are not equal.

The first thread execution unit 13 sets the address selection signal to an on state, and generates the next cycle fetch address “0x108” because the “TRUE” indicating the branch “taken” of the branch result shown in ID stage of the pre-cycle does not correspond.

The state transition circuit 43a receives the output “11” of the pre-state register 40d and the output (“not taken”) of the branch result, and generates the next state. The generated next state is transmitted to the first branch prediction table 15.

The state transition circuit 43a transfers the state from “11” to “10”, and the next state is changed to “10” in accordance with the state transition shown in FIG. 7.

In the pre-cycle, the WE 44c reads out the branch instruction execution signal having an on state from the first branch prediction table 15.

The WE 44c becomes an enable state, and writes the pre-prediction address “0x40” to first branch prediction table 15 as the write address. The WE 44c writes the generated next state to the first branch prediction table 15 at the end of the ID stage.

The instruction fetch unit 20a sets the branch instruction detection signal generated by the instruction decoder 21a to an off state because the instruction of the ID stage is not a branch instruction.

In the EXE stage, the address selection signal of the branch verifier 22a is an on state. The next cycle fetch address generated by the branch verifier 22a is selected as a read address for instruction of the next cycle. The selected next cycle fetch address is written to address register 31 (PC) at the end of the ID stage.

The instruction fetch unit 20a returns a program processing to the case where the branch of the conditional branch instruction is “not taken” when the instruction fetch unit 20a predicts that the process branches based on the conditional branch instruction, and the branch verifier 22a determines that branch condition is “not taken”.

The processor 1 cancels the process of the IF stage of the instruction “1w” of the address “0x164”, writes the next data to the pipeline register related with the instruction “1w” at the end of the IF stage, and deletes (flushes) the instruction “1w” of address “0x164” at a timing just before the instruction and the address are written to the registers A and B, as shown in FIG. 10(c).

As described above, when the branch result is a branch “not taken”, the branch predictor 12 cancels the program processing until the branch condition is fixed. A pipeline processor requires an extra one cycle for processing the conditional branch instruction because of deleting the instruction.

However, the success rate of the branch prediction is high compared with the failure rate because the processor 1 according to the embodiment employs two bits branch prediction system.

The second thread execution unit 14 is different from the first thread execution unit 13 in that the second thread execution unit 14 utilizes the second branch prediction table 16 when a program including a conditional branch instruction is processed. Other operations of the second thread execution unit 14 are similar to the first thread execution unit 13.

When a plurality of thread execution units execute parallel operation so as to increase the process performance, it can be impossible to divide the program to be processed into a plurality of threads.

In this case, the first thread execution unit 13 executes a program processing, and the second thread execution unit 14 is set to a halt state so as to reduce power consumption.

The processor 1 is rearranged by adding the second branch prediction table 16 associated with the second thread execution unit 14 to the first branch prediction table 15 so as to execute a branch prediction.

That is, the first thread execution unit 13 executes a branch prediction by utilizing the first branch prediction table 15 and the second branch prediction table 16 when the second thread execution unit 14 is in a halt state. The common flag 17 is set to “1” when the second thread execution unit 14 goes to a halt state.

In the halt state of the second thread execution unit 14, the first thread execution unit 13 processes a program. In the ID stage of the cycle C2 of the conditional branch instruction, the first branch prediction table 15 receives the address from lower (n+1) bit to lower third bit of the conditional branch instruction stored in the branch instruction address register 40a as a first branch instruction address.

When the table switch bit “T” is “0”, the MSB “M” to the LSB “L” of the branch instruction address register 40a are transmitted to the first branch prediction table 15 as a read address. Data having two bits length is read out from the first branch prediction table 15. The MSB “M” to the LSB “L” are transmitted to the pre-prediction address register 40b, as shown in FIG. 5.

The Data having two bits length is transmitted to the decision circuit 44a via the selector 42b. The decision circuit 44a transmits the branch prediction result to the pre-state register 40d. The pre-prediction address register 40b and the pre-state register 40d write the branch prediction result at the end of the ID stage.

The content of the first branch prediction table 15 is updated, based on the branch result generated in the EXE stage.

On the other hand, when the table switch bit “T” is “1”, the MSB “M” to the LSB “L” of the branch instruction address register 40a are transmitted to the second branch prediction table 16 via the selector 42a as the read address. The Data having two bits length is read out form the second branch prediction table 16, and is transmitted to the pre-state register 40e.

The second branch prediction table 16 transmits the Data having two bits length to the selector 42b and the decision circuit 44a. As a result, the branch prediction result is generated.

The branch instruction address register 40a writes input data to the pre-prediction address register 40c via the selector 42a at the end of the ID stage. The second branch prediction table 16 writes input data to the pre-state register 40e at the end of the ID stage.

In the EXE stage, the selectors 42c and 42d select the branch result of the first branch prediction table 15, and select the first branch instruction execution signal, based on the stored data obtained by the pre-select register 40f in the ID stage. An output of the selector 42c is transmitted to the state transition circuit 43b. An output of the selector 42d is transmitted to the WE 44d. As a result, the second branch prediction table 16 is updated.

In the feed back process of the first branch prediction table 15, the table switch bit “T” is set to “0”. The first branch prediction table 15 is updated, based on the branch prediction result of the first branch prediction table 15 and the branch result.

In the feed back process of the first branch prediction table 15, the table switch bit “T” is set to “1”. The first branch prediction table 16 is updated, based on the branch prediction result of the first branch prediction table 15 and the branch result.

The lower m bits of the branch instruction address access the first branch prediction table 15. A conditional branch instruction having an address having the same lower m bits address and a different upper address can be executed.

In this case, the first branch prediction table 15 of the branch predictor 12 executes a state transition in accordance with the branch prediction and the branch result utilizing an address having the same lower m bits address. When the lower m bits address is the same, the branch prediction information of different conditional branch instructions are merged in the first branch prediction table 15. As a result, it is possible to improve the performance of the processor by increasing the ratio of success of the branch prediction though the performance of the branch prediction decreases.

The branch predictor 12 according to the embodiment executes branch prediction by using a branch prediction table having capacities of the first and second branch prediction tables 15 and 16 in a period halting the second thread execution unit 14.

The probability that the addresses of the conditional branch instruction become equal goes to half, compared to a branch prediction only using the first branch prediction table 15. Therefore, it is possible to reduce a deterioration of the performance of branch prediction caused by merging. It is possible to provide the processor 1 with high performance of program processing without increasing circuit scale.

(Branch Prediction Method)

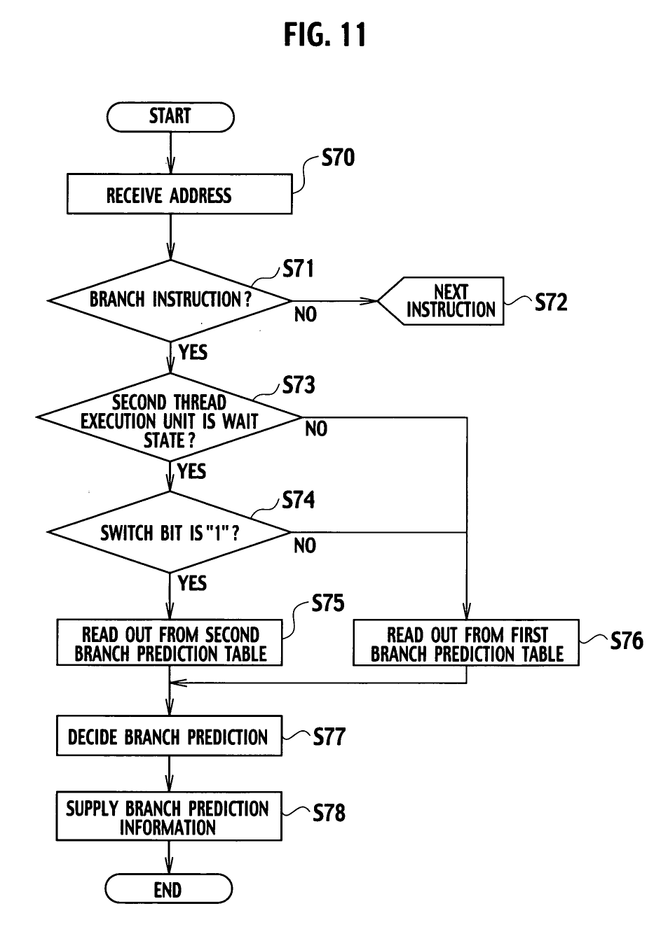

The branch prediction method of the branch predictor will be described by referring FIG. 11. The branch prediction method includes a step S70 for receiving a read address from the first thread execution unit 13, a step S71 for accessing first and second branch prediction tables 15 and 16 based on the read address, a step S73 for determining a wait state of the second thread execution unit 14, and steps S75 and S78 for supplying branch prediction information of the second thread execution unit 14 to the first thread execution unit 13 by reading the branch prediction information of the second thread execution unit 14 from the second branch prediction table 16 based on the read address when the second thread execution unit 14 is in a wait state.

Therefore, it is possible to improve the precision of the branch prediction of branch instructions by supplying branch prediction information of the second thread execution unit 14 to the first thread execution unit 13, and by reading the branch prediction information of the second thread execution unit 14 from the second branch prediction table 16 based on the read address when the second thread execution unit 14 is in a wait state.

In step S71, when a branch instruction is not read out, the procedure goes to step S72. In step S72, the value of the PC is changed to the next instruction.

In step S74, the table switch bit “T” of the branch instruction address register 40a is determined. For example, when the table switch bit “T” stores “1”, the switch circuit 41 switches an access from the first branch prediction table 15 to the second branch prediction table 16. As a result, the branch prediction information is read out.

The branch predictor 12 selects one of the first and second branch prediction tables 15 and 16 in accordance with an AND result of the table switch bit “T” and the common flag 17, and to supply read branch prediction information to the instruction fetch unit 20a.

When the second thread execution unit 14 is not in a wait state, the procedure goes to step S76. The branch prediction information of the first thread execution unit 13 is read out form the first branch prediction table 15. The read branch prediction information is transmitted to the first thread execution unit 13.

In step S75 or step S76, the decision circuit 44a analyses the branch prediction information. Then, the procedure goes to step S77.

(First Modification)

The first thread execution unit 13 executes a branch prediction sharing the first branch prediction table 15 and the second branch prediction table 16 by setting the common flag 17 shown in FIG. 1 to “1” by a program.

When a program processing is assigned to the second thread execution unit 14, the common flag 17 is not immediately changed to “0”, but the common flag 17 is controlled in accordance with the size or the content of the program assigned to the second thread execution unit 14.

When the second thread execution unit 14 processes a program with the common flag 17 of “1”, a fixed branch prediction is executed by constantly deciding branch “taken” in the case where the branch target address of the conditional branch instruction is smaller than the address of the branch instruction.

As described above, it is possible to increase the performance of the processor 1 by continuously utilizing the second branch prediction table 16 to the branch prediction of the first thread execution unit 13 when the size of a program executed by the thread execution unit 14 is small, and the deflection (the branch target address is smaller than the address of the branch instruction) of condition branch in processing the program is found out in preparing the program.

(Second Modification)

The common flag 17 shown in FIG. 1 is extended to a plurality of bits. Information of a thread execution unit using the shared branch prediction table is added to the extended common flag. With respect to the branch address of the branch predictor 12 shown in FIG. 1 and the selector 42, the branch address from the additional thread execution unit indicated by the added branch prediction information is supplied to the shared branch prediction table (first, second, or additional branch prediction table), and the branch prediction result is generated. It is possible to increase the precision of the branch prediction by providing the extended branch prediction table capable of writing branch result.

As described above, with respect to the second thread execution unit 14 or an additional thread execution unit, it is possible to increase the precision of the branch prediction by providing the extended branch prediction table, and by utilizing the extended branch prediction table. As a result, the program control becomes easy by increasing the flexibility of the program assignment for thread execution units as well as increasing the processing performance of the processor 1.

### OTHER EMBODIMENTS

Various modifications will become possible for those skilled in the art after receiving the teachings of the present disclosure without departing from the scope thereof.

In the aforementioned embodiment, description was given of an example in which the processor 1 includes two thread execution units. However, a processor including more than or equal to three thread execution units may be used.

The operation of five stages pipeline processor using delay slots for the transition period of each cycle has been described. However, a processor without the delay slots, or a processor having the different number of stages may be adapted to the branch predictor according to the embodiment.

With respect to the processor 1 employing a multi-thread system, the first and second thread execution units 13 and 14 dynamically (in executing a program) execute branch prediction by utilizing the first and second branch prediction tables 15 and 16, respectively. The first branch prediction table 15 is provided for the first thread execution unit 13. The second branch prediction table 16 is provided for second thread execution unit 14. The first thread execution unit 13 executes the branch prediction by utilizing the first and second branch prediction tables 15 and 16 when the second thread execution unit 14 does not utilize the second branch prediction table 16.

With respect to the branch prediction method for the processor employing a multi-thread system dynamically (in executing a program) executes branch prediction, branch prediction means are divided into at least the first and second branch prediction table 15 and 16 when the first and second thread execution units 13 and 14 dynamically (in executing a program) execute branch prediction. The first thread execution unit 13 executes the branch prediction by utilizing the first branch prediction table 15. The second thread execution unit 14 executes the branch prediction by utilizing the second branch prediction table 16. When the first thread execution unit 13 dynamically (in executing a program) executes branch prediction and the second thread execution unit 13 does not execute branch prediction. The first thread execution unit 13 executes the dynamic branch prediction by utilizing the first and second branch prediction tables 15 and 16.

A program executed by first thread execution unit 13 performs a control so that the first thread execution unit 13 dynamically (in executing a program) executes the branch prediction.

What is claimed is:

1. A branch predictor configured to communicate information between first and second thread execution units, comprising:
a first branch prediction table configured to store branch prediction information of the first thread execution unit;
a second branch prediction table configured to store branch prediction information of the second thread execution unit;
a read address register configured to access the first and second branch prediction tables based on a read address received from the first thread execution unit; and
a selector configured to select one of the first and second branch prediction tables in accordance with the read address, to read the branch prediction information of one of the first and second thread execution units, and to supply read branch prediction information to the first thread execution unit when the second thread execution unit is in a wait state.

2. The branch predictor of claim 1, wherein the selector selects the branch prediction information based on both a common flag indicating the wait state of the second thread execution unit and the read address.

3. The branch predictor of claim 2, wherein the common flag is controlled in accordance with a program assigned to the second thread execution unit.

4. The branch predictor of claim 1, further comprising a determination circuit connected to the selector and determines a probability of a branch taken of the branch prediction information

5. The branch predictor of claim 4, wherein the selector selects the branch prediction information based on both a common flag indicating the wait state of the second thread execution unit and the read address.

6. The branch predictor of claim 1, wherein the branch prediction information is updated in accordance with a verification result of whether a branch prediction is succeeded.

7. A processor comprising:
first and second thread execution units;
a first branch prediction table configured to store branch prediction information of the first thread execution unit;
a second branch prediction table configured to store branch prediction information of the second thread execution unit;
a read address register configured to access the first and second branch prediction tables based on a read address received from the first thread execution unit; and
a selector configured to select one of the first and second branch prediction tables in accordance with the read address, to read the branch prediction information of one of the first and second thread execution units, and to supply read branch prediction information to the first thread execution unit when the second thread execution unit is in a wait state.

8. The branch predictor of claim 7, wherein the selector selects the branch prediction information based on both a common flag indicating the wait state of the second thread execution unit and the read address.

9. The branch predictor of claim 8, wherein the common flag is controlled in accordance with a program assigned to the second thread execution unit.

10. The branch predictor of claim 7, further comprising a determination circuit connected to the selector and determines a probability of a branch taken of the branch prediction information.

11. The branch predictor of claim 10, wherein the selector selects the branch prediction information based on both a common flag indicating the wait state of the second thread execution unit and the read address.

12. The branch predictor of claim 7, wherein the branch prediction information is updated in accordance with a verification result of whether a branch prediction is succeeded.

13. A branch prediction method for communicating information between first and second thread execution units, comprising:
receiving a read address from the first thread execution unit;
accessing first and second branch prediction tables based on the read address;
determining a wait state of the second thread execution unit; and
supplying branch prediction information of the second thread execution unit to the first thread execution unit by reading the branch prediction information of the second thread execution unit from the second branch prediction table based on the read address when the second thread execution unit is in a wait state.

14. The branch prediction method of claim 13, wherein the supplying the branch prediction information comprises selecting the branch prediction information based on both a common flag indicating the wait state of the second thread execution unit and the read address.

15. The branch prediction method of claim 14, wherein the common flag is controlled in accordance with a program assigned to the second thread execution unit.

16. The branch prediction method of claim 13, further comprising determining a probability of a branch taken of the branch prediction information.

17. The branch prediction method of claim 16, wherein the supplying the branch prediction information comprises selecting the branch prediction information based on both a common flag indicating the wait state of the second thread execution unit and the read address.

18. The branch prediction method of claim 13, further comprising updating the branch prediction information in accordance with a verification result of whether a branch prediction is succeeded.
